(19) United States
(12) Patent Application Publication
(10) Pub. No.: US 2003/0215235 A1
(43) Pub. Date: Nov. 20, 2003

(54) Optical communication system for vehicle, signal relay apparatus and optical communication connector

(75) Inventors: Akira Norizuki, Shizuoka (JP); Yoshikazu Saito, Shizuoka (JP)

Correspondence Address: Finnegan, Henderson, Farabow,, Garrett & Dunner, L.L.P., 1300 I Street, N.W., Washington, DC, 20005-3315, US

(73) Assignee: YAZAKI CORPORATION

(21) Appl. No.: 10/434,218

(22) Filed: May 9, 2003

(30) Foreign Application Priority Data
May 17, 2002 (JP) 2002-143397
May 17, 2002 (JP) 2002-143402
Mar. 5, 2003 (JP) 2003-058865

(51) Int. Cl. H04B 10/00

(52) U.S. Cl. 398/59; 398/171

(57) ABSTRACT

A first J/B 11 is housed in an instrument panel 21. The first J/B 11 is connected through electric transmission lines 15 to electronic apparatuses A to C, coverts an optical signal from an optical transmission line 13 into an electric signal to output the electric signal to the electronic apparatuses A to C, and converts an electric signal entered from each of the electronic apparatuses A to C into an optical signal to send the optical signal to the optical transmission line 13. A second J/B 12 is housed in a trunk room 22. The second J/B 12 is connected through the optical transmission line 13 to the first J/B 11 and through electric transmission lines 15 to one or a plurality of electronic apparatuses E and F, converts an optical signal from the optical transmission line 13 into an electric signal to output the electric signal to the electronic apparatuses E and F, and converts an electric signal entered from each of the electronic apparatuses E and F into an optical signal to send the optical signal to the optical transmission line.

### BACKGROUND OF THE INVENTION

1. Field of the Invention

The present invention relates to an optical communication system for interconnecting, through an optical transmission line, a plurality of electronic apparatuses which are installed in a vehicle, and to a signal relay apparatus and an optical communication connector in this optical communication system.

2. Description of the Related Art

Conventionally, as a data transmission system for transmitting data in a vehicle, a system has been known, which lays an optical fiber cable in the vehicle and transmits non-time series data such as commands, or time series data such as video data by use of the optical fiber cable.

In the data transmission system, there is a synchronous ring-type network designed to transmit time series audio data, video data and the like. Through this synchronous ring-type network, data transmission is carried out by interconnecting communication apparatuses in a ring shape and synchronizing data transmission timing among the communication apparatuses.

As shown in FIG. 1, such a synchronous ring-type network is constituted in a manner that electronic apparatuses A, B and C are arranged in the vicinity of a front seat in a vehicle front portion, an electronic apparatus D is arranged in the vicinity of a rear seat, and further, electronic apparatuses E and F are arranged in a trunk room of a vehicle rear portion. The electronic apparatuses are interconnected in the ring shape through an optical transmission line 101 and optical connectors 102, and data is transmitted while an optical signal is being relayed in a given direction among the electronic apparatuses.

However, there has been a problem in the conventional ring-type network. For example, even when the conventional ring-type network is connected to an electronic apparatus arranged in an instrument panel or a trunk room of a limited internal volume, the electronic apparatus must be connected to the optical transmission line 101, and it is therefore difficult to deal with the excessive length of the optical fiber cable in a narrow place such as a backside of the electronic apparatus of the instrument panel or the like.

Another problem in the conventional ring-type network is a cost increase resulted from the necessity of disposing an optical interface in each electronic apparatus. Meanwhile, a problem in an electric network is generation of noise caused by, for example, integration of many electric wires in a harness for interconnecting the front and rear portions of the vehicle.

In the conventional synchronous ring-type network, due to the necessity of laying the optical fiber cable and the optical connectors in the vehicle, there is a limit on wiring arrangements in general. In other words, conventionally, a harness integrating electric power lines, electric control lines and the like and an electric junction box (J/B) for supplying power to the electronic apparatuses or controlling electric connection thereof have been installed while arranging positions thereof in the vehicle are being regulated. The optical fiber cable has been arranged along the harness to the vicinity of the J/B and connected through a dedicated in-line connector while detouring the J/B.

Conventionally, in the case of constituting the ring-type optical fiber cable of an optical connection portion and an optical branch portion, which are formed of the optical connectors, an optical power loss has occurred in the optical connection portion or the optical branch portion to limit the number of optical connection portions or optical branch portions. As a result, limitations have been placed on a wiring path for the optical fiber cable and arranging positions for the electronic apparatuses operated by optical signals.

Furthermore, in the conventional synchronous ring-type network, even if new electronic apparatuses are to be connected to the optical fiber cable to expand functions, no means have been actually provided therefore.

### SUMMARY OF THE INVENTION

The present invention has been proposed in view of the foregoing actual circumstances. It is an object of the present invention to provide an optical communication system for a vehicle and a signal relay apparatus, which are capable of reducing costs for the entire system and noise in a harness portion and of building a transmission line for an electronic apparatus installed in a narrow place.

It is another object of the present invention to provide an optical communication system, a signal relay apparatus and an optical communication connector, which optimize wiring arrangements of an optical transmission line in a ring-type optical network and facilitate expansion of an electronic apparatus.

To solve the problems described above, an optical communication system for a vehicle according to a first aspect of the present invention is constituted as follows. First and second electronic apparatus sections are disposed on a front portion and a rear portion in the vehicle respectively. In a first case, the first electronic apparatus section houses first photoelectric conversion means for converting an optical signal from an optical transmission line into an electric signal to output the electric signal to an electronic apparatus and for converting an electric signal entered from the electronic apparatus into an optical signal to send the optical signal to the optical transmission line, where the first photoelectric conversion means is being connected to the electronic apparatus through an electric transmission line. In a second case, the second electronic apparatus section houses, second photoelectric conversion means for converting an optical signal from the optical transmission line into an electric signal to output the electric signal to at least one electronic apparatus and for converting an electric signal entered from the electronic apparatus into an optical signal to send the optical signal to the optical transmission line, where the second photoelectric conversion means is being connected to the first photoelectric conversion means of the first electronic apparatus section through the optical transmission line and to the electronic apparatus through an electric transmission line.

According to the optical communication system for a vehicle in accordance with the first aspect of the present invention, the first and second electronic apparatus sections are disposed on the front portion and the rear portion in the vehicle respectively, the transmission line between the first and second electronic apparatuses is constituted of the optical transmission line, and the transmission lines between the first electronic apparatus section and the electronic apparatus and between the second electronic apparatus section and the electronic apparatus are constituted of the electric transmission lines. Thus, the optical interfaces need to be disposed only in the first and second electronic apparatus sections while it is unnecessary to mount any optical interfaces on the electronic apparatuses. Thus, it is possible to reduce costs of the entire system.

According to the optical communication system for a vehicle, the short-distance transmission lines in the first and second cases are constituted of the electric transmission lines, and the long-distance transmission line for interconnecting the vehicle front and rear portions with more electric noise is constituted of the optical transmission line. Thus, the electric noise can be reduced in the portion for interconnecting the front and rear portions of the vehicle.

Furthermore, according to the optical communication system for a vehicle, it is unnecessary to arrange any optical transmission lines in a place with a small internal volume, whereby wiring arrangements of a transmission line in the electronic apparatuses can be simplified.

A signal relay apparatus according to a second aspect of the present invention in an optical communication system, in which a plurality of electronic apparatuses are connected in a ring shape in a vehicle and a signal is relayed among the electronic apparatuses, is constituted to include photoelectric conversion means for converting an optical signal from an optical transmission line into an electric signal and for converting an entered electric signal into an optical signal to send the optical signal to the optical transmission line, and at least one electric transceiver means for outputting an electric signal from the photoelectric conversion means to the electronic apparatus and receiving the electric signal relayed among the electronic apparatuses to output the electric signal to the photoelectric conversion means, where the electric transceiver means being connected to the electronic apparatuses through an electric transmission line.

According to the signal relay apparatus in accordance with the present invention, the electronic apparatus including only the electric interface can be connected to the optical transmission line. Thus, even if a transmission medium is switched, the electronic apparatus can be switched, and the electronic apparatus using the optical signal and the electronic apparatus using the electric signal can be shared.

An optical communication system according to a third aspect of the present invention is a system for carrying out a process in accordance with an optical signal entered through an optical fiber cable and for interconnecting, in a ring shape, a plurality of electronic apparatuses sending the optical signal entered through the optical fiber cable to other adjacent electronic apparatuses to allow the electronic apparatuses to communicate with one another. In order to interconnect the electronic apparatuses in the ring shape, the system includes a plurality of signal relay apparatuses including a plurality of photoelectric conversion means for converting an optical signal entered from the connected electronic apparatus into an electric signal to output the electric signal to other photoelectric conversion means and for converting an electric signal entered from the other photoelectric conversion means into an optical signal to output the optical signal to the electronic apparatus, where the photoelectric conversion means is being disposed at least corresponding to the electronic apparatuses, and a cable connector for converting an optical signal transmitted from one optical fiber cable into an electric signal and converting an electric signal into an optical signal to send the optical signal to the other optical fiber cable, the cable connecter being connected to a plurality of optical fiber cables.

According to the optical communication system, even in the system in which the optical fiber cable is laid to connect the electronic apparatuses in the vehicle into the ring shape, photoelectric conversion is carried out at the signal relay apparatus connected to the plurality of electronic apparatuses to reduce an optical power loss, and photoelectric conversion is carried out at the cable connector for connecting the plurality of optical fiber cables. Thus, the optical fiber cables can be arranged and connected without considering any optical power loss, whereby the wiring arrangements of the optical transmission line can be made optimal and expansion of the electronic apparatuses can be facilitated.

A signal relay apparatus according to a fourth aspect of the present invention is a signal relay apparatus in an optical communication system in which a plurality of electronic apparatuses are connected in a ring shape in a vehicle and an optical signal is relayed among the electronic apparatuses by use of an optical fiber cable, including a plurality of photoelectric conversion means for converting an optical signal entered from the connected electronic apparatus into an electric signal to output the electric signal to other photoelectric conversion means and for converting an electric signal entered from the other photoelectric conversion means into an optical signal to output the optical signal to the electronic apparatus, where the photoelectric conversion means is being disposed at least corresponding to the electronic apparatuses.

According to the signal relay apparatus, even in the system in which the optical fiber cable is laid to connect the electronic apparatuses in the vehicle into the ring shape, the optical signal from each of the plurality of electronic apparatuses is subjected to photoelectric conversion to reduce an optical power loss. Therefore, the optical fiber cables can be arranged and connected without considering any optical power loss. Thus, it is possible to optimize wiring arrangements of the optical transmission line and to facilitate expansion of electronic apparatuses.

An optical communication connector according to a fifth aspect of the present invention is an optical communication connector in an optical communication system in which a plurality of electronic apparatuses are connected in a ring shape in a vehicle and an optical signal is relayed among the electronic apparatuses by use of an optical fiber cable, the optical communication connector including first photoelectric conversion means for converting an optical signal transmitted from one optical fiber cable into an electric signal and for converting an entered electric signal into an optical signal to send the optical signal, and second photoelectric conversion means for converting an electric signal from the first photoelectric conversion means into an optical signal to send the optical signal to the other optical fiber cable and for converting an entered optical signal into an electric signal to output the electric signal to the first photoelectric conversion means. In the optical communication connector as described above, the first photoelectric conversion means or the second photoelectric conversion means includes amplification means for amplifying the entered electric signal or the converted electric signal.

According to the optical communication connector, even in the system in which the optical fiber cable is laid to connect the electronic apparatuses in the vehicle into the ring shape, the amplification means for amplifying the electric signal entered to the first or second photoelectric conversion means or the converted electric signal is disposed. Therefore, the optical fiber cables can be arranged and connected without considering any optical power loss. Thus, it is possible to optimize wiring arrangements of the optical transmission line and to facilitate expansion of electronic apparatuses.

### BRIEF DESCRIPTION OF THE DRAWINGS

FIG. 1 is a block diagram showing a configuration of a conventional optical communication system.

FIG. 2 is a block diagram showing a configuration of an optical communication system to which the present invention is applied.

FIG. 3 is a view illustrating constitutional examples of a first J/B and a second J/B.

FIG. 4 is a block diagram illustrating internal constitutions of the first J/B and the second J/B.

FIG. 5 is a block diagram showing constitutions of first and second photoelectric conversion sections.

FIG. 6 is a perspective view schematically showing an appearance of the J/B to which the present invention is applied.

FIG. 7 is a block diagram showing an electric constitution of the J/B to which the present invention is applied.

FIG. 8 is a view schematically showing an appearance of a short-pin connector to which the present invention is applied.

FIG. 9 is a block diagram showing an electric constitution of the short-pin connector to which the present invention is applied.

FIG. 10 is a block diagram showing an electric constitution of another J/B to which the present invention is applied.

FIG. 11 is a block diagram for explaining electric connection between the other J/B and an electronic apparatus, which the present invention is applied to.

FIG. 12 is a flowchart showing a process when each switch circuit is controlled by a switch control section.

FIG. 13 is a view schematically showing an appearance of an in-line connector to which the present invention is applied.

FIG. 14 is a block diagram showing an electric constitution of the in-line connector to which the present invention is applied.

FIG. 15 is a view schematically showing an appearance of an expansion optical connector to which the present invention is applied.

FIG. 16 is a view schematically showing an appearance of anther expansion optical connector to which the present invention is applied.

FIG. 17 is a block diagram showing an electric constitution of the expansion optical connector to which the present invention is applied.

FIG. 18 is a block diagram showing a constitution of the photoelectric conversion section.

FIG. 19 is a time chart for explaining an operation of the photoelectric conversion section: Reference symbol (a) indicates a change in an optical signal level; reference symbol (b) indicates a change in an outputted electric signal; and reference symbol (c) indicates a change in a status determination signal.

FIG. 20 is a view for explaining a process of switching a status of a switch circuit by the photoelectric conversion section: Reference symbol (a) indicates a change in a status determination signal; and reference symbol (b) indicates a change in a status of the switch circuit.

FIG. 21 is a block diagram showing a configuration of another optical communication system.

FIG. 22 is a block diagram showing a constitution of a photoelectric conversion interface to which the present invention is applied.

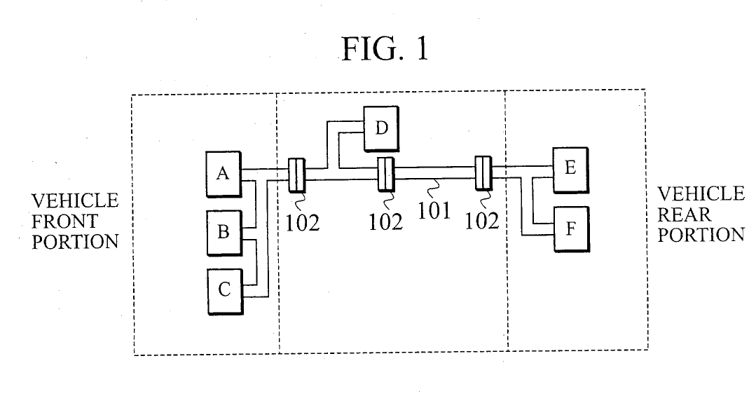

### DETAILED DESCRIPTION OF THE PREFERRED EMBODIMENT

Hereinafter, an embodiment of the present invention will be described with reference to the accompanying drawings.

[Constitution of Optical Communication System]

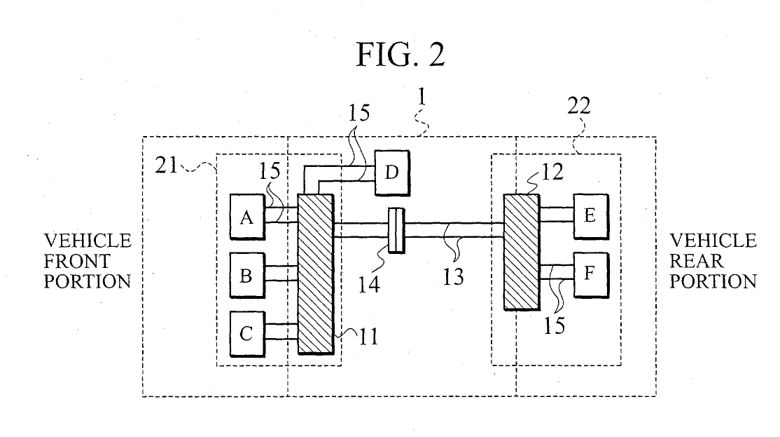

The present invention is applied to, for example, an optical communication system configured as shown in FIG. 2.

This optical communication system is configured by arranging electronic apparatuses A, B and C in an instrument panel in the vicinity of a front seat on the front portion of a vehicle, an electronic apparatus D in the vicinity of a rear seat, and further electronic apparatuses E and F in a trunk room of the vehicle rear portion. In a vehicle 1 on which the optical communication system is mounted, for structural and electric wiring reasons, a first junction box (J/B) 11 is disposed to be limited in the vicinity between the front and rear seats, and a second J/B 12 is disposed to be limited in the vicinity between the rear seat and the trunk room.

In this optical communication system, the first J/B 11 and the electronic apparatuses A, B and C are housed in a first housing box 21 constituting the instrument panel, and the second J/B 12 and the electronic apparatuses E and F are housed in a second housing box constituting the trunk room.

A harness which integrates, for example, power lines for supplying power to other electronic apparatuses not constituting the optical communication system, control lines for detecting or controlling statuses of the other electronic apparatuses, in-line connectors or the like is connected to the first J/B 11 and the second J/B 12. Thus, the first J/B 11 and the second J/B 12 convert and supply power from a battery, and supply control signals to defined electronic apparatuses.

The harness connected to the first J/B 11 and the second J/B includes an optical fiber cable which is an optical transmission line 13 constituting the optical communication system. This optical fiber cable is arranged to connect the first J/B 11 and the second J/B 12, and an in-line connector 14 is disposed in the optical transmission line 13 which connects the first J/B 11 and the second J/B 12. The first J/B 11, the second J/B 12 and the electronic apparatuses A to F are connected by an electric transmission line 15 not included in the harness.

The optical transmission line 13 for connecting the first J/B 11 and the second J/B 12, and the electric transmission line 15 are constituted so that the length of the optical transmission line 13 is longer than that of the electric transmission line 15.

In this optical communication system, the electronic apparatuses A to F are connected in a ring shape, and the electronic apparatuses A to F relay an optical signal among adjacent electronic apparatuses A to F in synchronization, whereby the optical signal is relayed in a sequence of, for example, the electronic apparatus A, the electronic apparatus D, the electronic apparatus E, the electronic apparatus F, the electronic apparatus C, the electronic apparatus B and the electronic apparatus A. At this time, each of the electronic apparatuses A to F carries out a signal synchronizing process in accordance with a communication protocol predetermined by the optical communication system. Then, each of the electronic apparatuses A to F adds the address of an electronic apparatus of a destination to transmit the optical signal. Upon reception of the optical signal from the adjacent electronic apparatus, each of the electronic apparatuses A to F receives the optical signal if the apparatus itself is a destination, or relays the optical signal to the adjacent electronic apparatus if the apparatus itself is not a destination.

[First Constitutional Example of First J/B 11 and Second J/B 12]

Next, constitutional examples of the first J/B 11 and the second J/B 12 will be described. In the description, since the first J/B 11 and the second J/B 12 are similarly constituted, the first J/B 11 and the second J/B 12 are generically called “J/B.”

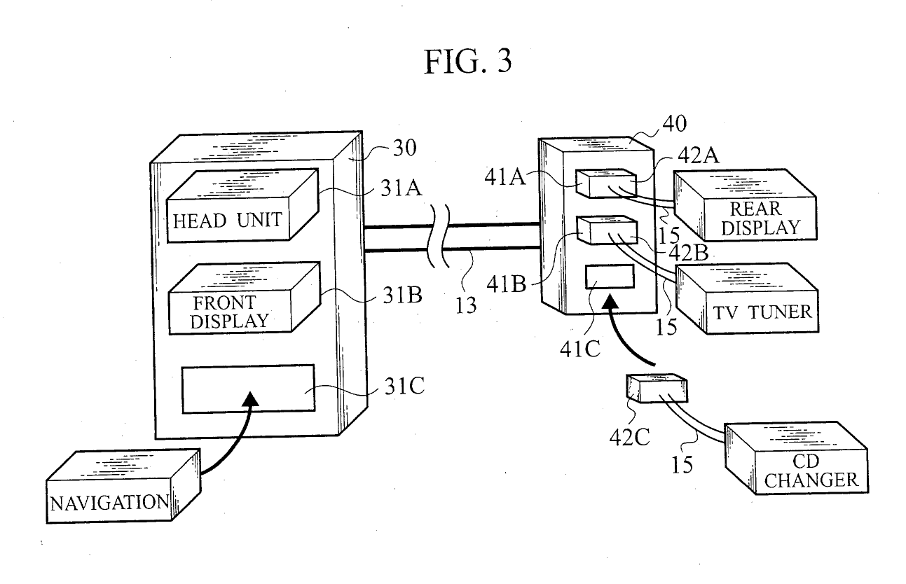

As shown in FIG. 3, the first J/B 11 is housed in the first housing box 21, and a plurality of electronic apparatus connection slots 31A, 31B and 31C are disposed in a housing box 30, in positions which can be viewed from vehicle occupants. For example, a head unit, a front display and a navigation apparatus are inserted into the first J/B 11 as electronic apparatuses. These electronic apparatuses are connected by the internal electric transmission line 15 through the electronic connection slots 31, and further, the electric transmission line 15 and the optical transmission line 13 are connected thereto.

The second J/B 12 is housed in a second housing box 22, and a plurality of electronic apparatus connection sections 41A, 41B and 41C are disposed in a housing box 40. For example, a rear display, a TV tuner and a CD changer are connected as electronic apparatuses to the second J/B 12 through electric connectors 42A, 42B and 42C. These electronic apparatuses are connected to the inside of the housing box 40 through the electronic apparatus connection section 41, the electric connector 42 and the electric transmission line 15, and further, the internal electric transmission line 15 and the optical transmission line 13 are connected thereto.

In an example shown in FIG. 3, two structures are shown: a slot structure where the electronic apparatus connection slot 31 is disposed in the housing box 30 to insert the electronic apparatus, and a pigtail structure where the electronic apparatus connection section 41 is disposed in the housing box 40 to insert the electric connector 42, and the electric connector 42 is connected to the electronic apparatus through the electric transmission line 15. Either structure maybe employed, and further, other structures may be employed.

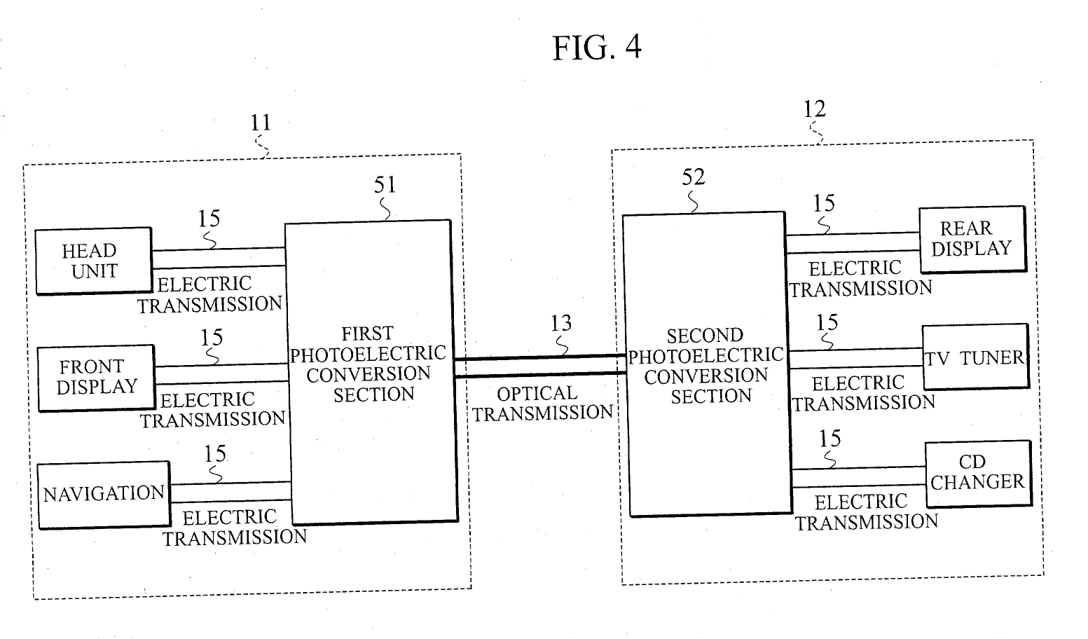

In the first J/B 11 and the second J/B 12, as electric constitutions thereof are shown in FIG. 4, first and second photoelectric conversion sections 51 and 52 are interconnected through the optical transmission line 13.

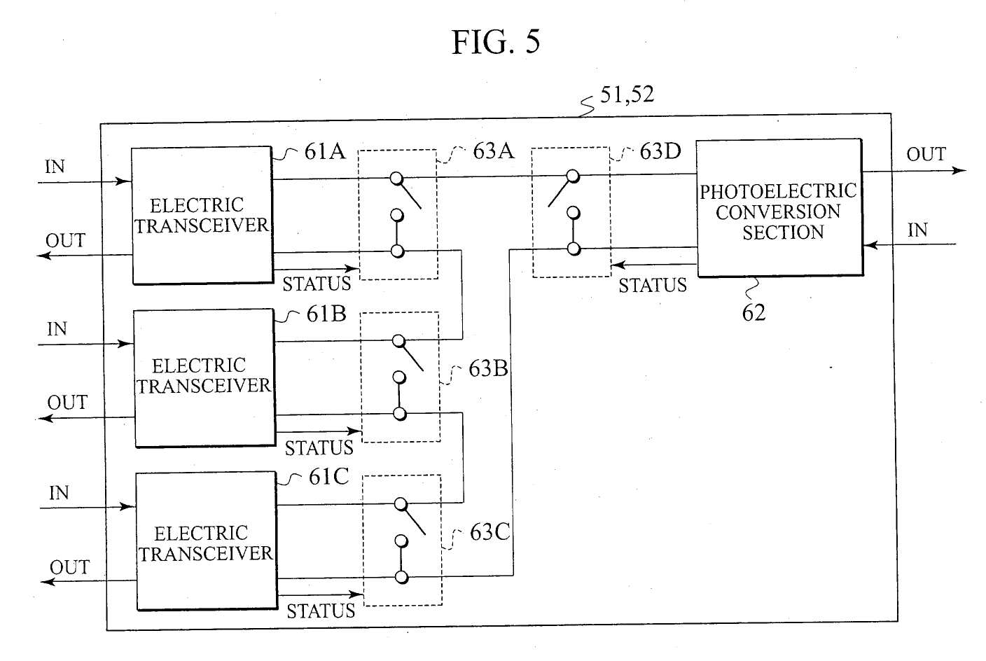

Each of the first and second photoelectric conversion sections 51 and 52, as internal constitution thereof is shown in FIG. 5, includes electric transceivers 61A, 61B and 61C connected to the electric apparatuses A, B and C through the electric transmission line 15, and a photoelectric conversion section 62 connected to the optical transmission line 13. Moreover, each of the first and second photoelectric conversion sections 51 and 52 includes switch circuits 63A, 63B and 63C and a switch circuit 63D respectively connected to electric signal input/output terminals of each of the electric transceivers 61A, 61B and 61C and the photoelectric conversion section 62. The electric transceivers 61A to 61C and the photoelectric conversion section 62 are connected through an internal electric wiring.

In each of such first and second photoelectric conversion sections 51 and 52, the photoelectric conversion section 62, the electric transceiver 61C, the electronic apparatus C, the electric transceiver 61B, the electronic apparatus B and the electric transceiver 61A are connected in a ring shape. In other words, each of the first and second photoelectric conversion sections 51 and 52 is constituted so that when an optical signal is entered to the photoelectric conversion section 62, an electric signal can be relayed in a sequence of the electric transceiver 61C, the electronic apparatus C, the electric transceiver 61C, the electric transceiver 61B, the electronic apparatus B, the electric transceiver 61B, the electric transceiver 61A, the electronic apparatus A, the electric transceiver 61A and the photoelectric conversion section 62.

In addition, the switch circuits 63A to 63D have functions to bypass and relay the electric signal from the adjacent electric transceivers 61A, 61B and 61C or the photoelectric conversion section 62. Opening/closing operations of the switch circuits 63A to 63D are controlled by status determination signals (status) from the corresponding electric transceivers 61A to 61C, and 61D, respectively.

Upon entry of the optical signal from the optical transmission line 13, the photoelectric conversion section 62 converts the optical signal into an electric signal in accordance with an optical signal level, and outputs the electric signal to the electric transceiver 61C. At this time, the photoelectric conversion section 62 monitors the optical signal level and outputs the converted electric signal after amplifying and modulating the converted electric signal when the received optical signal level is larger than a predetermined value indicating reception of a normal optical signal. On the other hand, when the received optical signal level is smaller than the predetermined value indicating non-reception of a normal optical signal, the photoelectric conversion section 62 closes the switch circuit 63D by a status control signal.

Upon reception of the electric signal, the electric transceivers 61 modulate and amplify the electric signal, and output the electric signal through the electric transmission line 15 to the electronic apparatus. Upon reception of the electric signal from the electronic apparatus through the electric transmission line 15, the electric transceiver 61 outputs the electric signal to one of the adjacent electric transceivers 61. At this time, the electric transceiver 61 monitors an electric signal level and controls an opening/closing operation of the switch circuit 63 as in the case of the photoelectric conversion section 62 described above.

According to such an optical communication system, since the transmission line for connecting the first J/B 11 and the second J/B 12 is constituted of the optical transmission line 13, and the transmission line for connecting the first J/B 11 and the second J/B 12 to the electronic apparatus is constituted of the electric transmission line 15, the optical interfaces need to be disposed only in the first J/B 11 and the second J/B 12, while it is unnecessary to mount any optical interfaces in the electronic apparatuses. Thus, it is possible to reduce costs of the entire system.

In addition, according to the optical communication system, the short-distance transmission line in the instrument panel or the trunk room with less electric noise is constituted of the electric transmission line 15, and the long-distance transmission line in the harness portion for connecting the vehicle front and rear portions with more electric noise is constituted of the optical transmission line 13. Thus, application of electric noise by electric signal transmission or power supplying to communication data is prevented in the harness portion, whereby data noise can be reduced. Simultaneously, electric noise in the harness portion in the harness portion can be also reduced more compared with the case of transmitting communication data through electric wires.

Furthermore, according to the optical communication system, it is unnecessary to arrange any optical transmission lines in a place with a small internal volume such as an instrument panel or a trunk room, whereby cable-arrangement of a transmission line in the electronic apparatuses can be simplified.

[Second Constitutional Example of First J/B and Second J/B]

Next, the second constitutional example of the first J/B 11 and the second J/B 12 will be described. In the following description, since the first J/B 11 and the second J/B 12 are similarly constituted, the first J/B 11 and the second J/B 12 are generically called “J/B.”

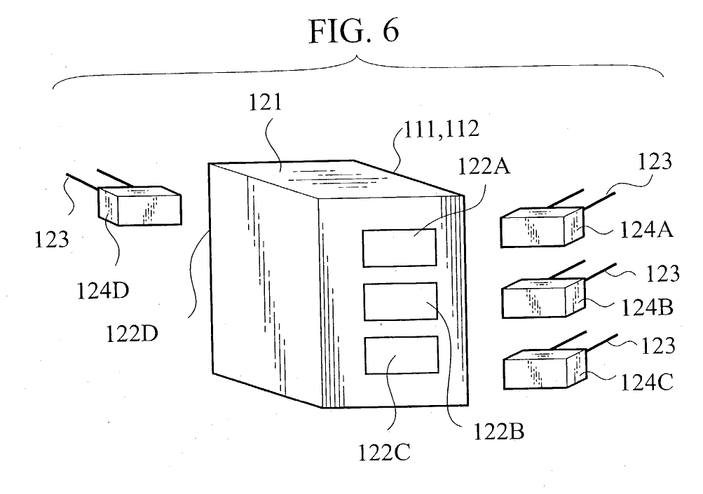

As shown in FIG. 6, this J/B includes a plurality of poles of expansion connection sections 122A, 122B, 122C and 122D in a housing box 21. Expansion connectors 124A to 124D to which optical fiber cables 123 are connected are respectively inserted into the expansion connection sections 122A to 122D. This example shows a case where the expansion connector 124D of one pole connected to the optical fiber cable 123 indicated as, for example, an optical transmission line 13 is connected to the expansion connection section 122D, and electronic apparatuses expanded and added to the expansion connection sections 122A to 122C of three poles are interconnected. An explanation will be given of cases where the optical transmission line 13 is connected to the expansion connector 124D, an electronic apparatus A is connected to the expansion connector 124A, an electronic apparatus B is connected to the expansion connector 124B, and an electronic apparatus C is connected to the expansion connector 124C.

The J/B functions as an expansion box, and the expansion connector 124 is inserted into the expansion connection section 122, whereby the electronic apparatuses connected to the optical fiber cable 123 of the expansion connector 124 constitute an optical communication system. In other words, when the expansion connector 124 is connected to the expansion connection section 122 to expand a new electronic apparatus, a ring-type network is constituted of the existing optical transmission line 13 and the optical fiber cable 123, and this electronic apparatus is added to the optical communication system to reconstitute the optical communication system.

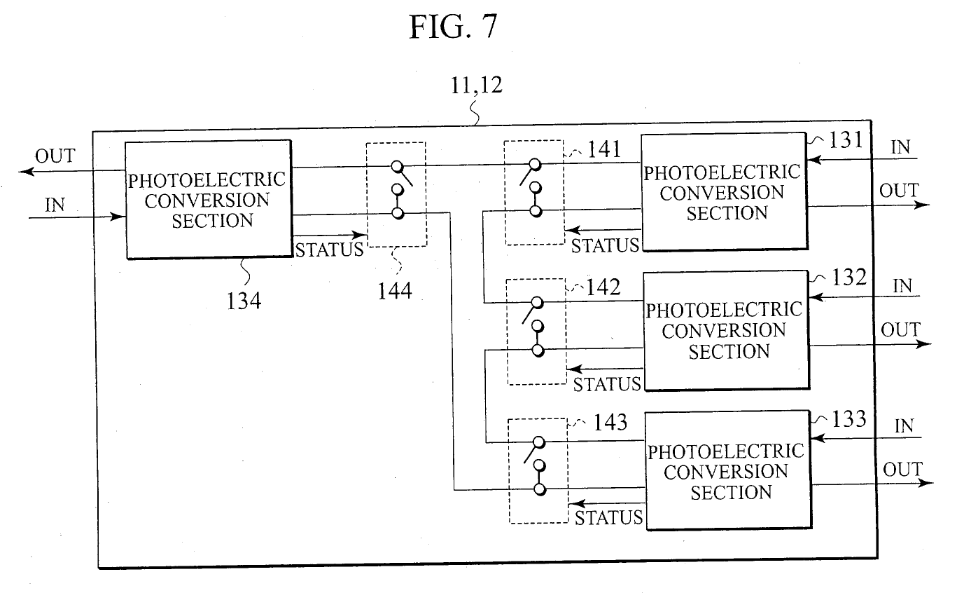

As shown in FIG. 7, the J/B includes a first photoelectric conversion section 131 corresponding to the expansion connection section 122A, a second photoelectric conversion section 132 corresponding to the expansion connection section 122B, a third photoelectric conversion section 133 corresponding to the expansion connection section 122C, and a fourth photoelectric conversion section 134 corresponding to the expansion connection section 122D. In this J/B, the fourth photoelectric conversion section 134 is electrically connected to the third photoelectric conversion section 133, likewise for the third photoelectric conversion section 133 to the second photoelectric conversion section 132, the second photoelectric conversion section 132 to the first photoelectric conversion section 131, and the first photoelectric conversion section 131 to the fourth photoelectric conversion section 134.

In the J/B, in a state where the expansion connectors 124A to 124D are respectively connected to the expansion connection sections 122A to 122D, and the electronic apparatuses A to C are respectively connected to the expansion connectors 124A to 124C, the fourth photoelectric conversion section 134, the third photoelectric conversion section 133, the electronic apparatus C, the second photoelectric conversion section 132, the electronic apparatus B, the first photoelectric conversion section 131, and the electronic apparatus A are interconnected in a ring shape. In the J/B, when the expansion connector 124D is connected to the fourth photoelectric conversion section 134 to enter an optical signal, the signal is relayed in a sequence of the third photoelectric conversion section 133, the electronic apparatus C, the third photoelectric conversion section 133, the second photoelectric conversion section 132, the electronic apparatus B, the second photoelectric conversion section 132, the first photoelectric conversion section 131, the electronic apparatus A, the first photoelectric conversion section 131, and the fourth photoelectric conversion section 134.

Moreover, the J/B includes a first switch circuit 141, a second switch circuit 142, a third switch circuit 143 and a fourth switch circuit 144 disposed in signal input/output sides of the photoelectric conversion sections 131 to 134. These switch circuits 141 to 144 have functions to bypass and relay electric signals from the adjacent photoelectric conversion sections. Opening/closing operations of the first to fourth switch circuits 141 to 144 are controlled by status determination signals (status) from the corresponding first to fourth photoelectric conversion sections 131 to 134.

In the J/B, when the expansion connectors 124A to 124D are connected to the expansion connection sections 122A to 122D, optical signals of normal levels are entered to the first to fourth photoelectric conversion sections 131 to 134. Accordingly, the first to fourth switch circuits 141 to 144 are kept open. Thus, the ring-type network is constituted of the optical fiber cable 123 connected to the expansion connectors 124A to 124D.

On the other hand, for example, if the expansion connector 124A is not connected to the expansion connection section 122A, the optical signal cannot be relayed because of non-connection of the electronic apparatus A even if an optical signal is outputted from the first photoelectric conversion section 131. In this case, the first switch circuit 141 is kept closed. Accordingly, even if the optical signal is relayed from the second photoelectric conversion section 132 to the first photoelectric conversion section 131, the first photoelectric conversion section 131 is bypassed by the first switch circuit 141 to enable sending of the optical signal to the fourth photoelectric conversion section 134.

Therefore, according to the J/B, connection/non-connection of the expansion connectors 124A to 124D is determined by the first to fourth photoelectric conversion sections 131 to 134, and the opening/closing of the first to fourth switch circuit 141 to 144 is controlled by a status determination signal, whereby an expansion and a change of the electronic apparatuses of the optical communication system can be electrically realized.

Additionally, according to the J/B, since the constitution is employed where a power supply line and a control signal supply line are incorporated as in the case of the existing system and the photoelectric conversion sections are incorporated to convert the signal from the optical transmission line 13 into the electric signal, amplify the electric signal and convert the signal into the optical signal again, the optical fiber cable can be arranged as in the case of the other harness to realize an optimal cable-arrangement path.

Moreover, according to the J/B, since the entered optical signal is converted into the electric signal and further converted into the optical signal to be outputted, no power loss as in normal optical connection occurs due to optical connection. Thus, stable communications can be assured.

Further, in the aforementioned example, an example was explained in which the first J/B 11 and the second J/B 12 have the expansion functions. Not limited to this, however, an expansion dedicated apparatus including a plurality of the aforementioned expansion connection sections 122 may be installed in the vehicle, and the J/B may be connected to the expansion dedicated apparatus, whereby it becomes possible to expand or change the optical communication system more flexibly and easily.

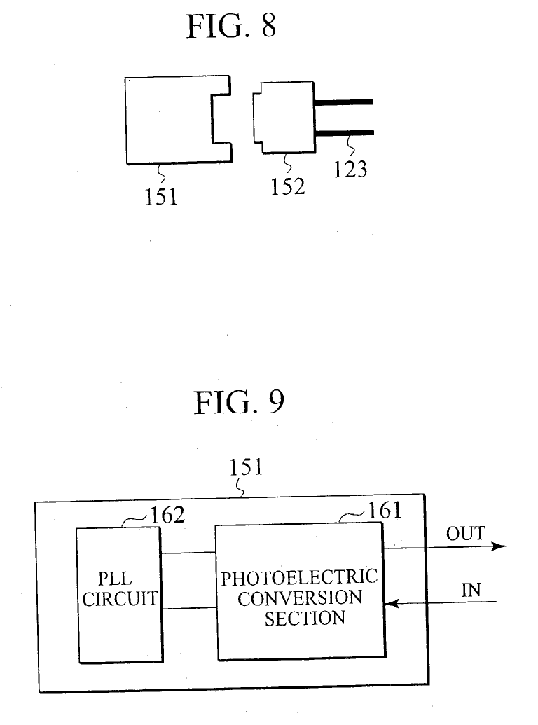

Furthermore, the present invention is not limited to the aforementioned case of expanding or changing the optical communication system by controlling the opening/closing of the switch circuits 141 to 144, but for the expansion connection section 122 to which the electronic apparatus is not connected, a short-pin connector 151 which appearance is schematically shown in FIG. 8 may be connected to the expansion connectors 124A to 124D. In other words, the expansion connectors 124A to 124D are connected to the expansion connection sections 122A to 122D, and an optical connector 152 is disposed in the other end through the optical fiber cable 123 of the expansion connectors 124A to 124D, and the short-pin connector 151 is connected to the optical connector 152.

For this short-pin connector 151, as its electric constitution thereof is shown in FIG. 9, a phase locked loop (PLL) circuit 162 for synchronizing an electric signal in the electric signal output end of each photoelectric conversion section is disposed in the photoelectric conversion section 161. The PLL circuit 162 carries out a process similar to synchronization when the optical signal is relayed by a communication IC incorporated in the electronic apparatus.

By connecting the short-pin connector 151 to the expansion connection section 122 through the optical fiber cable 123, even if the electronic apparatus is not connected, the ring-type network can be constituted while synchronizing in the optical communication system. Then, in the optical communication system, if a new electronic apparatus is connected for expansion from the state where the short-pin connector 151 is connected to the expansion connection section 122, the electronic apparatus can be connected thereto in place of the short-pin connector 151. Thus, the system can be easily expanded or changed.

[Third Constitutional Example of J/B]

Next, a description will be given according to a J/B of a third constitutional example, which is different from the aforementioned second constitutional example.

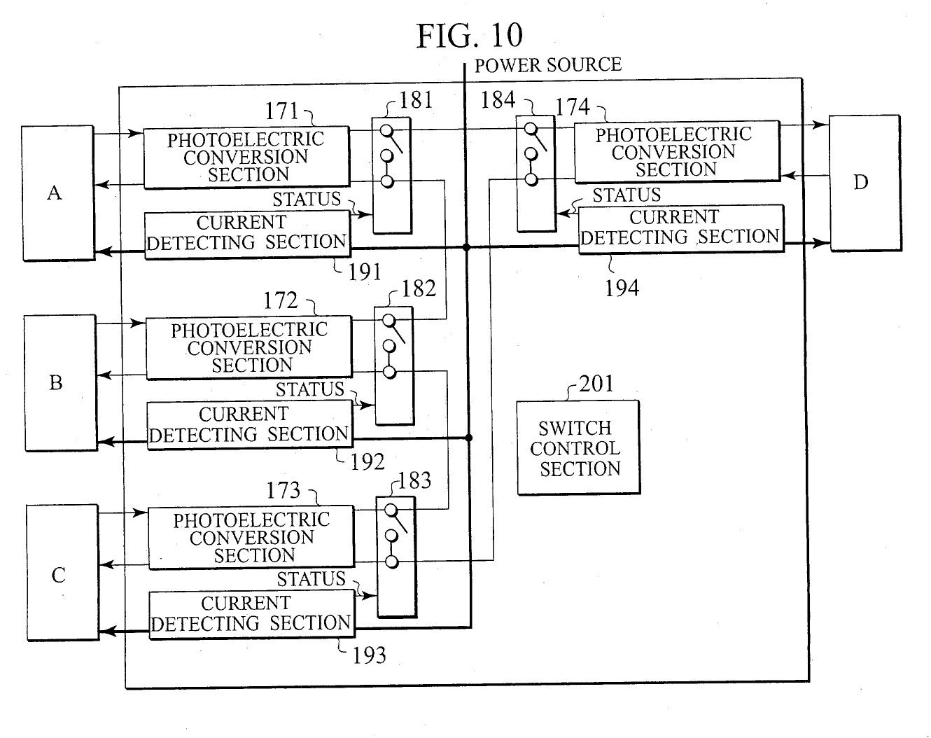

As shown in FIG. 10, this J/B is different from the aforementioned J/B in terms of the following: current detecting sections 191 to 194 and a switch control section 201 connected to the electronic apparatuses A to D in addition to photoelectric conversion sections 171 to 174 having functions that are equivalent of those of the photoelectric conversion sections 131 to 134 and connected to each of the electronic apparatuses A to D, and switch circuits 181 to 184 connected to the photoelectric conversion sections 171 to 174. This J/B is connected to an external power source and constituted for power from the external power source to enable to be supplied to the electronic apparatuses A to D through the current detecting sections 191 to 194.

The current detecting sections 191 to 194 are constituted of, for example, resistors or the like having power-supply-detecting functions for detecting power supply and detect the state of a power supply from the external power source to each of the electronic apparatuses A to D. If it is judged by the resistors having the power supply detecting functions that the electronic apparatuses A to D are not connected, the current detecting sections 191 to 194 generate status determination signals similar to those outputted from the photoelectric conversion sections 131 to 134, and output the signals to the switch control section 201. Specifically, the current detecting sections 191 to 194 output status determination signals of L levels because of no current flowing when the electronic apparatuses A to D are not connected, and output status determination signals of H levels because of current flowing when the electronic apparatuses A to D are connected.

The switch circuits 181 to 184 are opened/closed in accordance with control of the switch control section 201 based on the status determination signals from the current detecting sections 191 to 194. Specifically, the switch circuits 181 to 184 become an opened (off) state by the switch control section 201 when the status determination signals from the current detecting sections 191 to 194 are at H levels, and a closed (on) state by the switch control section 201 when the status determination signals from the current detecting states 191 to 194 are at L levels. Thus, the switch circuits 181 to 184 enable changing of bypassed states of the photoelectric conversion sections 171 to 174 for the electronic apparatuses.

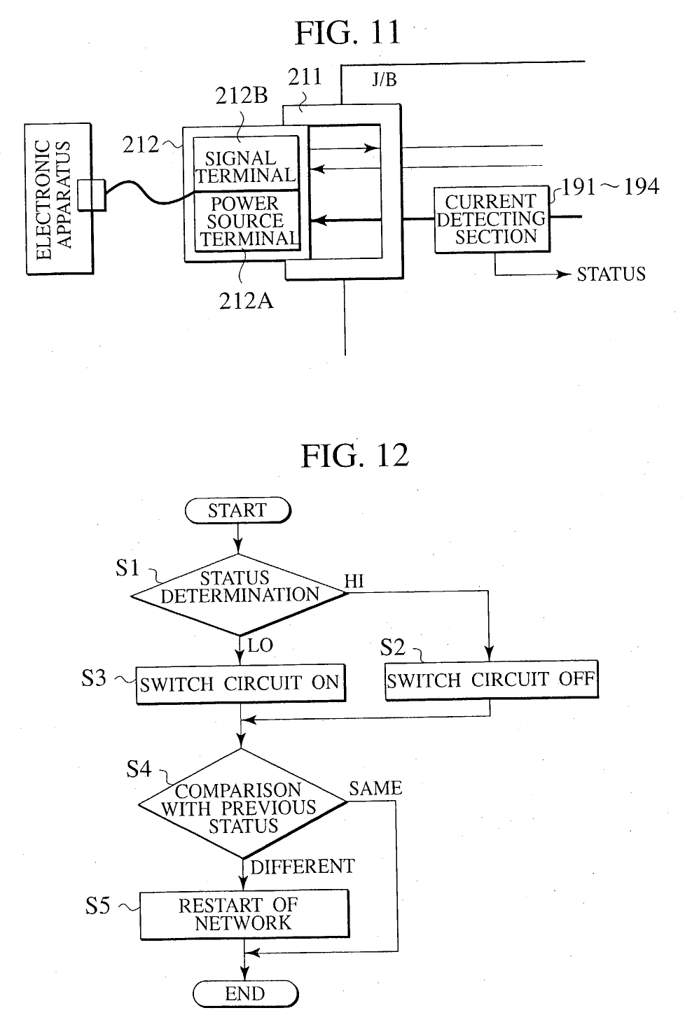

As shown in FIG. 11, when the electronic apparatuses A to D and the J/B are electrically connected by mechanically connecting an expansion connector connecting section 211 and an expansion connector 212 constituting the expansion connection section 122, the current detecting sections 191 to 194 are electrically connected to the electronic apparatuses A to D through a power supply terminal 212A in the expansion connector 212. Additionally, the expansion connector 212 further includes a signal terminal 212B and relays the optical signal between the electronic apparatuses A to D and the photoelectric conversion sections 171 to 174 through the signal terminal 212B.

In the J/B, for example, if the electronic apparatuses B and D are connected, the switch control section 201 opens the switch circuits 182 and 184, and closes the other switch circuits 181 and 183 to build a ring network.

When the ring network is constituted to carry out communications between the electronic apparatuses, for example, if a user operates connector insertion to connect a new electronic apparatus A, electricity conduction between the external power source and the electronic apparatus A is detected by the current detecting section 191. Accordingly, the switch control section 201 changes the switch circuit 181 from the closed state to an open state based on the status determination signal from the current detecting section 191. Thus, the switch control section 201 can build a ring network where the electronic apparatus A is newly connected in addition to the electronic apparatuses B and D. At this time, a master apparatus for controlling signal transmission/reception between the ring networks recognizes the electronic apparatus A newly added to the ring network and notifies this to the electronic apparatuses B and D to enable re-synchronization of the electronic apparatuses A, B and D, and enables communications through the ring network.

On the other hand, when the electronic apparatuses A, B and D constitute a ring network and communications are carried out among the electronic apparatuses, for example, if the user carries out a connector pulling-out operation to pull out the electronic apparatus B from the J/B, the stop of electricity conduction between the external power source and the electronic apparatus B is detected by the current detecting section 192. In response to this, the switch control section 201 changes the switch circuit 182 from the open state to the closed state based on the status determination signal from the current detecting section 192. Thus, the switch control section 201 builds a ring network where the electronic apparatus A is removed from the electronic apparatuses A, B and D. At this time, the master apparatus for controlling signal transmission/reception between the ring networks recognizes the electronic apparatus A removed from the ring network, and notifies it to the electronic apparatuses B and D to enable re-synchronization of the electronic apparatuses B and D, and enables communications through the ring network.

Now, such a process of the switch control section 201 will be described by referring to a flowchart of FIG. 12. First, in step S1, a level of status determination signal (Status) of each of the current detecting sections 191 to 194 is determined by the switch control section 201. In the case of an H level, connection of the electronic apparatuses is determined to open each of the switch circuits 181 to 184 (off) (step S2). In the case of an L level, non-connection of the electronic apparatuses is determined to close each of the switch circuits 181 to 184 (on) (step S3).

Then, when the ring network is constituted to carry out communications between the electronic apparatuses, the switch control section 201 compares the level of the status determination signal of each of the current detecting section 191 to 194 determined in step S1 with the level of a previous status determination signal (step S4), and finishes the process if the level determined in step S1 is equal to the previous level for all the electronic apparatuses. If the level of even one of the electronic apparatuses is different, determining that the electronic apparatus for any one of the photoelectric conversion sections 171 to 174 has been removed, the ring network is started again to finish the process (step S5).

According to the optical communication system having the J/B of the second constitutional example, even during the communications carried out by constituting the ring network, the removal of the electronic apparatuses for the J/B is detected by the current detecting sections 191 to 194, and in order to re-constitute the ring network, the switch control section 201 controls the opening/closing of the switch circuits 181 to 184 to enable rebuilding of the ring network. Accordingly, hot plug-and-play of the ring network can be realized. Therefore, according to the optical communication system, system changing or expansion can be easily conducted.

Moreover, according to the optical communication system, system changing or expansion is possible without changing the photoelectric conversion sections 171 to 174. In other words, connection/non-connection of the electronic apparatuses can be determined without using any status determination signals of the photoelectric conversion elements, and system change or expansion is possible irrespective of design items or the like such as output responsiveness of the status determination signals of the photoelectric conversion elements.

[Constitution of In-line Connector 114]

Next, a description will be given of a constitution of the in-line connector 114 in the foregoing optical communication system.

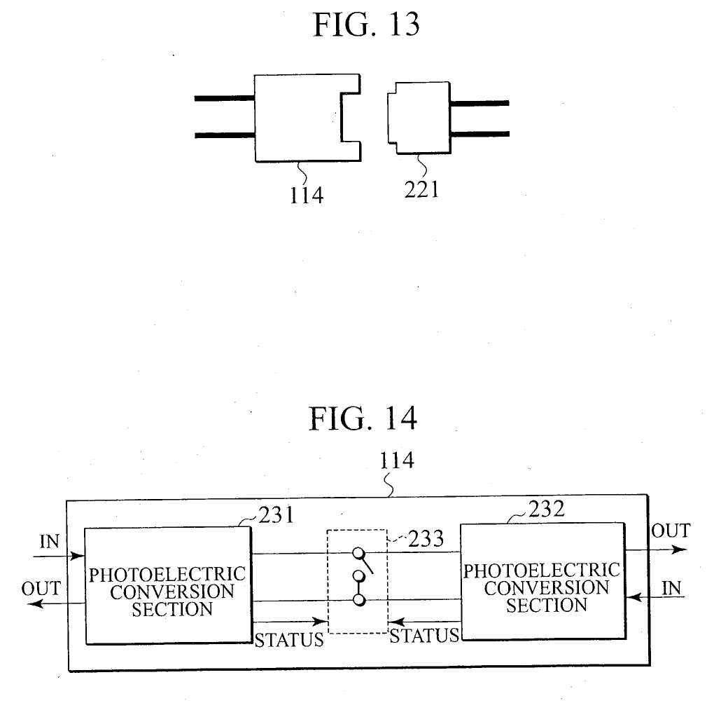

The in-line connector 114 is connected to an optical connector 221 as appearance thereof is schematically shown in FIG. 13. As shown in FIG. 2, the in-line connector 114 is connected to, for example, the first J/B 11, and the optical connector 221 is connected to the second J/B 12.

The in-line connector 114, as internal constitution thereof is shown in FIG. 14, includes a photoelectric conversion section 231 connected through the optical transmission line 13 to the first J/B 11, a photoelectric conversion section 232 connected through the optical transmission line 13 to the second J/B 12, and a switch circuit 233 disposed between the photoelectric conversion sections 231 and 232.

If an optical signal level from the first J/B 11 is equal to/lower than a predetermined value or if an optical signal level from the second J/B 12 is equal to/lower than a predetermined value, the photoelectric conversion sections 231 and 232 output status determination signals to the switch circuit 233 to set a closed state.

In this in-line connector 114, the closed state is set to enable to constitute an optical communication system including the electronic apparatuses F and E, or an optical communication system including the electronic apparatuses C, B, A and D.

The photoelectric conversion section 231 has a function to amplify an electric signal entered from the photoelectric conversion section 232 or a converted electric signal. The photoelectric conversion section 232 has a function to amplify an electric signal entered from the photoelectric conversion section 231 or a converted electric signal. In other words, the photoelectric conversion sections 231 and 232 have functions to amplify an optical signal at an electric signal stage. Each of the photoelectric conversion sections 231 and 232 amplifies an electric signal level to be equal, for example, to a predetermined optical signal level defined in the optical communication system.

According to the in-line connector 114, when the optical communication system is configured, amplification can be carried out inside thereof even if a plurality of connection relay sections are disposed. Accordingly, no power loss occurs. Thus, it is possible to realize an optimal cable-arrangement path of a wire harness without building a cable-arrangement path of optical fiber cables preparing for the optical power loss.

[Other Constitution of Optical Connector]

Next, a description will be given of a constitution of an expansion optical connector in the aforementioned optical communication system.

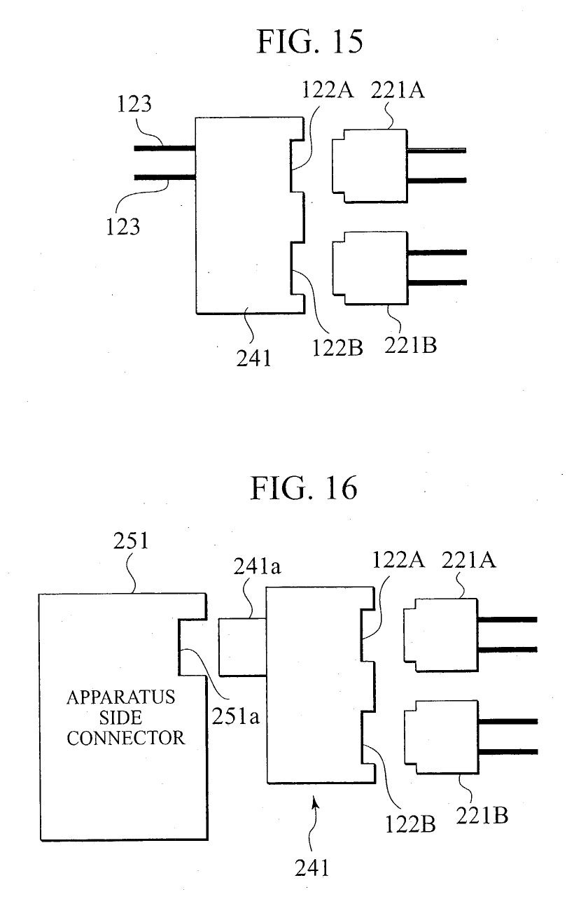

As shown in FIG. 15, an expansion optical connector 241 includes expansion connection sections 122A and 122B having two poles with respect to an optical fiber cable 123 having one pole. The expansion optical connector 241 is constituted in a manner that an optical connector 221A is attached to/detached from the expansion connection section 122A, and an optical connector 221B is attached to/detached from the expansion connection section 122B.

As shown in FIG. 16, the expansion optical connector 241 includes an expansion connection section 241a connected to a connecting section 251a of a machine side connector 251 of the electronic apparatus. The connecting section 251a is attached to/detached from the expansion connection section 241a, the optical connector 221A is attached to/detached from the expansion connection section 122A, and the optical connector 221B is attached to/detached from the expansion connection section 122B.

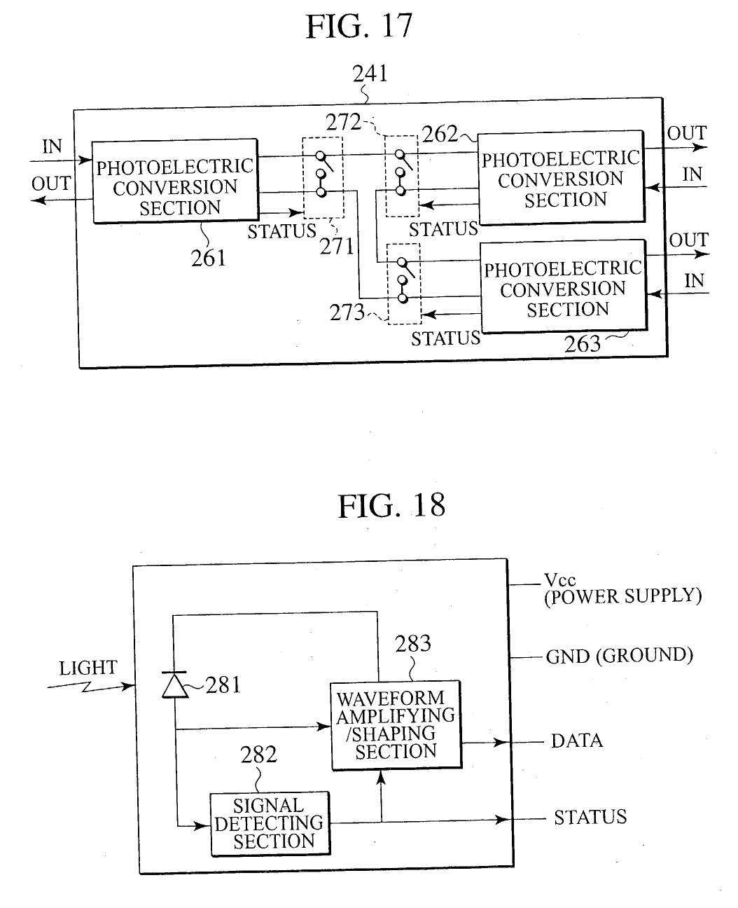

The expansion optical connector 241 includes a plurality of poles of expansion connection sections 122 with respect to an optical input/output terminal having one pole, therefore an expansion or a change of the optical communication system can be easily conducted. The expansion optical connector 241, as electric constitution thereof is shown in FIG. 17, includes a photoelectric conversion section 261 constituting an optical input/output terminal having one pole, and photoelectric conversion sections 262 and 263 constituting optical input/output terminals of two poles. Additionally, in electric signal input/output terminals of the photoelectric conversion sections 261 to 263, switch circuits 271 to 273 are respectively disposed as in the aforementioned case.

Such an expansion optical connector 241 judges the attachment/detachment of the optical connectors 221A and 221B by the photoelectric conversion sections 262 and 263 to control opening/closing of the switch circuits 272 and 273. Moreover, each of the photoelectric conversion sections 261 to 263 has a function to amplify an electric signal level to be set equal to a predetermined optical signal level defined in the optical communication system.

According to the expansion optical connector 241, if it is used as an in-line connector of the optical communication system, for example, in a form shown in FIG. 15, by interconnecting a plurality of optical connectors 221, an optical signal from a single optical fiber cable 123 can be relayed through the plurality of optical connectors 221, and sent to the single optical fiber cable 123. Thus, it is possible to easily expand or change the optical communication system.

According to the expansion optical connector 241, if it is used in a form shown in FIG. 16, a newly introduced adjacent electronic apparatus can be expanded and connected to the electronic apparatus having the machine side connector 251. Thus, without changing the constitution of the internal J/B of the vehicle or the connector of the expansion exclusive apparatus, electronic apparatuses can be expanded or changed by changing connection to the machine side connector 251 disposed in the electronic apparatus relatively near the user.

[Constitution of Photoelectric Conversion Section]

Next, a description will be given of the photoelectric conversion sections incorporated in the J/B, expansion/exclusive apparatus the in-line connector 114, the expansion optical connector 241, etc. mentioned above.

As shown in FIG. 18, each of such photoelectric conversion sections includes a light receiving section 181 for receiving the optical signal from the optical transmission line, a signal detecting section 182, and a waveform amplifying/shaping section 183. The photoelectric conversion section also includes a power supply terminal, and a GND terminal driven by receiving power supply Vcc from a battery and a power supply line which are not shown.

Upon entry of the optical signal to the light receiving section 281, the photoelectric conversion section generates an electric signal of which level changes in accordance with a change in the optical signal level, and sends the signal to the waveform amplifying/shaping section 283. At this time, the signal detecting section 282 monitors the optical signal level received by the light receiving section 281 and, if the entry of the optical signal of a stable constant level or more is determined, generates a status determination signal of an L (low) level by determining that the normal optical signal has been entered. On the other hand, if non-entry of the optical signal of a stable constant level or more to the light receiving section 281 is determined, the signal detecting section 282 generates a status determination signal of an H (high) level by determining that the normal optical signal has not been entered. This status determination signal is sent to the waveform amplifying/shaping section 283 and the switch circuit.

Upon entry of the status determination signal of the L level, the waveform amplifying/shaping section 283 amplifies and shapes the electric signal generated by the light receiving section 281 to, for example, a preset electric signal level, and outputs the electric signal to the adjacent photoelectric conversion section. Meanwhile, upon entry of the status determination signal of the H level, the waveform amplifying/shaping section 283 does not output the electric signal from the light receiving section 281.

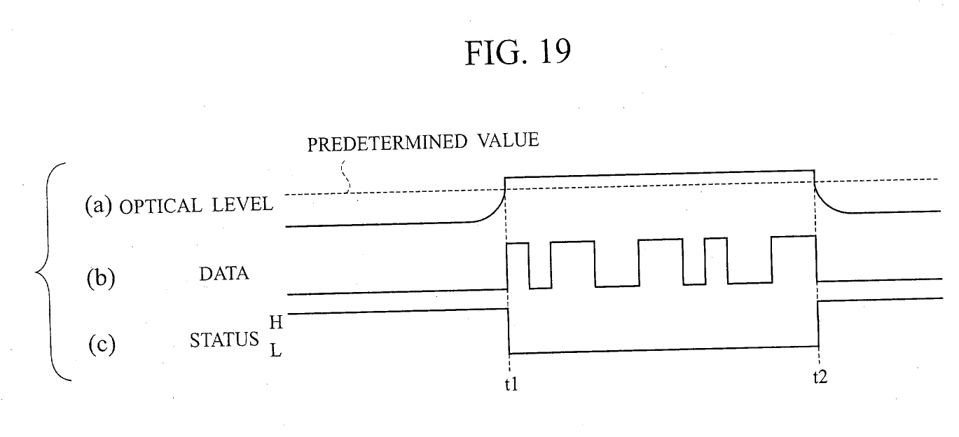

In other words, in the photoelectric conversion section, as shown in FIG. 19, when the optical signal level from the optical transmission line becomes a predetermined value or higher at time t1 (FIG. 19(a)), the status determination signal is changed from the H level to the L level (FIG. 19(c)), and output of the electric signal (DATA) generated by the light receiving section 281 from the waveform amplifying/shaping section 283 is started (FIG. 19(b)). At this time, the switch circuit is changed from the closed state to the open state to output the electric signal from the adjacent photoelectric conversion section to the electronic apparatus, and convert the optical signal from the electric apparatus and output it to the other photoelectric conversion section.

Then, for example, when fragmentation or the like of the optical transmission line occurs, and non-entry of the optical signal of the predetermined value or more to the light receiving section 281 is detected by the signal detecting section 282 at time t2 (FIG. 19(a)), the status determination signal is changed from the L level to the H level (FIG. 19(c)). According to this, the switch circuit is changed from the open state to the closed state to bypass the entered electric signal.

In other words, for example, if the electronic apparatus or the optical connector is not connected to the expansion connection section 122 and the optical signal entering the photoelectric conversion section does not reach the predetermined level, the status determination signal of the H level is supplied to the switch circuit to close the switch circuit, whereby the electric signal from the adjacent photoelectric conversion section is bypassed.

As described above, in each photoelectric conversion section, attaching/detaching of the electronic apparatus or the optical connector can be judged from the optical signal level.

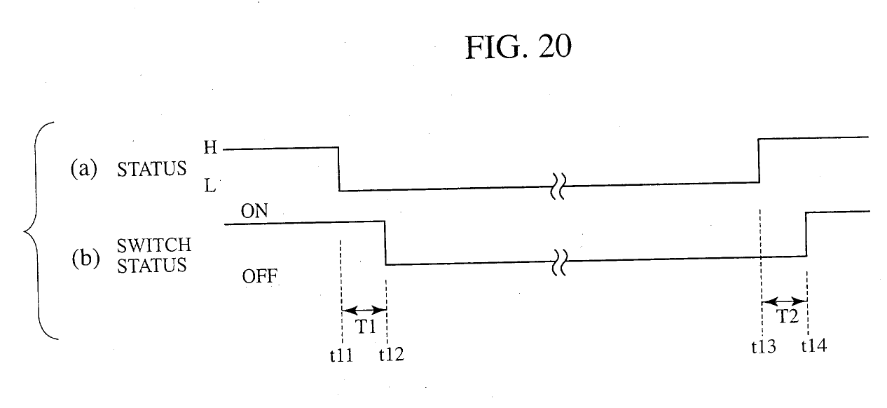

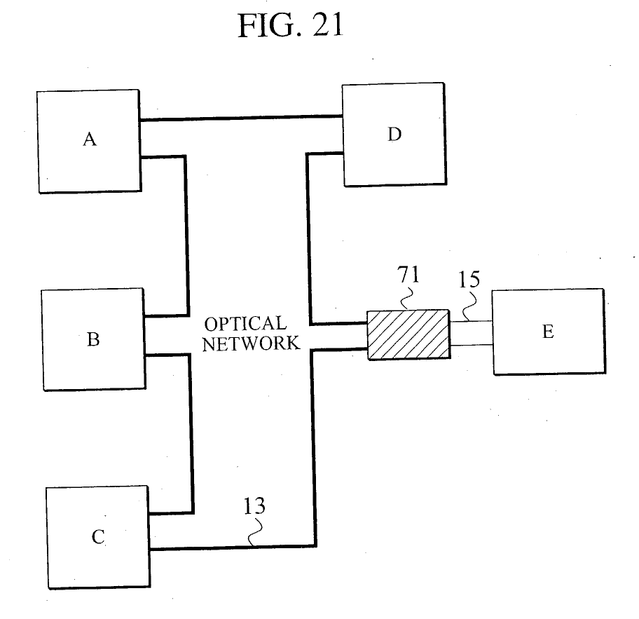

In addition, regarding the control of the opening/closing of the switch circuit, as shown in FIG. 20, the signal detecting section 282 controls output timing for the status determination signal to be sent to the switch circuit for after the lapse of predetermined time required for the stable status lapse determination, when the status determination signal is changed from the H level to the L level to switch the closed state to the open state or when the status determination signal is changed from the L level to the H level to switch the open state to the closed state. In other words, as shown in FIG. 20(a), the signal detecting section 282 outputs the status determination signal to the switch circuit after the lapse of predetermined time T1 from time t11 when the optical signal level becomes a predetermined value or higher at the light receiving section 281, thereby changing the switch circuit from the closed state (on) to the open state (off) at time t12 (FIG. 20(b)). As shown in FIG. 20(a), the signal detection section 282 outputs the status determination signal to the switch circuit after the lapse of time T2 after time t13 when the optical signal level becomes a predetermined level or lower at the light receiving section 281, thereby changing the switch circuit from the open state (off) to the closed state (on) at time t14 (FIG. 20(b)).

Thus, by controlling the switching timing of the switch circuit, it is possible to judge the attachment/detachment of the electronic apparatus or the optical switch.

[Other Constitution of Optical Communication System]

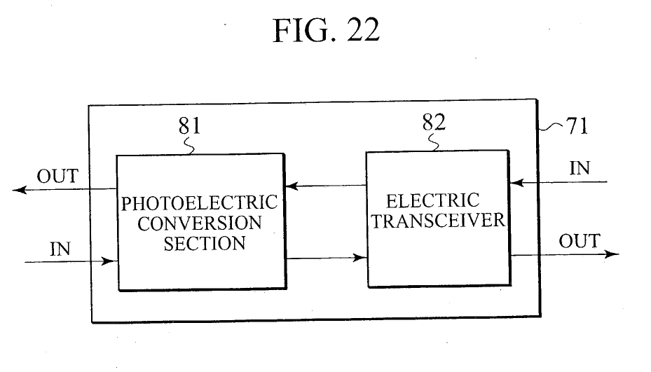

Next, the other configuration of the optical communication system will be described by referring to FIGS. 21 and 22. In the description below, portions similar to the above are denoted by similar reference numerals, and detailed explanation thereof will be omitted.

As shown in FIG. 21, the optical communication system is configured by connecting electronic apparatuses A to D, a photoelectric conversion interface 71, and an electronic apparatus E by an optical transmission line 13 and an electric transmission line 15 to be a ring shape. In this case, the electronic apparatuses A to D include optical interfaces, while the electronic apparatus E includes an electric interface. In this optical communication system, for example, the electronic apparatuses A to C are housed in an instrument panel in the front portion of a vehicle, and the electronic apparatuses D and E and the photoelectric conversion interface 71 are housed in a trunk room in the rear portion of the vehicle.

The photoelectric conversion interface 71 includes a photoelectric conversion section 81 connected to the optical transmission line 13, and an electric transceiver 82 connected through the electric transmission line 15 to the electronic apparatus E as internal constitution thereof is shown in FIG. 22. The photoelectric conversion section 81 has a function similar to that of the aforementioned photoelectric conversion section 62, and the electric transceiver 82 has a function similar to that of the aforementioned photoelectric conversion section 62.

According to this optical communication system, by connecting the photoelectric conversion interface 71 to the optical transmission line 13, the electronic apparatus E including only the electric interface can be connected. Therefore, even if a transmission medium is changed, the electronic apparatuses can be switched, and the electronic apparatus using the optical signal and the electronic apparatus using the electric signal can be shared.

The foregoing embodiment is only an example of the present invention. Thus, it is obvious that the present invention is not limited to the foregoing embodiment but other embodiments and various modifications can be made in accordance with designing and the like if the other embodiments are in the range not departing from the technical ideas of the invention.

What is claimed is:

1. An optical communication system for a vehicle in which a plurality of electronic apparatuses are interconnected in a ring shape in the vehicle and a signal is relayed among the electronic apparatuses, the optical communication system comprising:
a first electronic apparatus section housing, in a first case, at least one electronic apparatus and first photoelectric conversion means for converting an optical signal from an optical transmission line into an electric signal to output the electric signal to the electronic apparatus and converting an electric signal entered from the electronic apparatus into an optical signal to send the optical signal to the optical transmission line, the first photoelectric conversion means being connected through an electric transmission line to the electronic apparatus; and
a second electronic apparatus section housing, in a second case, at least one electronic apparatus and second photoelectric conversion means for converting an optical signal from the optical transmission line into an electric signal to output the electric signal to the electronic apparatus and converting an electric signal entered from the electronic apparatus into an optical signal to send the optical signal to the optical transmission line, the second photoelectric conversion means being connected through the optical transmission line to the first photoelectric conversion means of the first electronic apparatus section and connected through an electric transmission line to the at least one electronic apparatus,
wherein the first electronic apparatus section is disposed on a front portion in the vehicle, and the second electronic apparatus section is disposed on a rear portion in the vehicle.

2. An optical communication system for a vehicle according to claim 1, wherein the optical transmission line is constituted such that a transmission line length thereof is longer compared with the electric transmission line of the first electronic apparatus section and the electric transmission line of the second electronic apparatus section.

3. An optical communication system for a vehicle according to claim 1, wherein the first case comprises an instrument panel, the second case comprises a trunk room, and the optical transmission line is arranged to interconnect the instrument panel and the trunk room.

4. A signal relay apparatus in an optical communication system in which a plurality of electronic apparatuses are connected in a ring shape in a vehicle and a signal is relayed among the electronic apparatuses, the signal relay apparatus comprising:
photoelectric conversion means for converting an optical signal from an optical transmission line into an electric signal and converting an entered electric signal into an optical signal to send the optical signal to the optical transmission line; and
at least one electric transceiver means for outputting an electric signal from the photoelectric conversion means to the electronic apparatus and receiving the electric signal relayed among the electronic apparatuses to output the electric signal to the photoelectric conversion means, the electric transceiver means being connected through an electric transmission line to the electronic apparatuses.

5. An optical communication system in which a plurality of electronic apparatuses are connected in a ring shape in a vehicle and an optical signal is relayed among the electronic apparatuses by use of an optical fiber cable, the optical communication system comprising:
a plurality of electronic apparatuses for carrying out a process in accordance with the optical signal entered through the optical fiber cable and sending the optical signal entered through the optical fiber cable to other adjacent electronic apparatuses;
a plurality of signal relay apparatuses including a plurality of photoelectric conversion means for converting an optical signal entered from the connected electronic apparatus into an electric signal to output the electric signal to other photoelectric conversion means and converting an electric signal entered from the other photoelectric conversion means into an optical signal to output the optical signal to the electronic apparatus, the photoelectric conversion means being disposed at least corresponding to the electronic apparatuses; and
a cable connector for converting an optical signal transmitted from one optical fiber cable into an electric signal and converting an electric signal into an optical signal to send the optical signal to the other optical fiber cable, the cable connecter being connected to a plurality of optical fiber cables.

6. An optical communication system according to claim 5, wherein any of each signal relay apparatus and the cable connector amplifies the converted electric signal, converts the amplified electric signal into an optical signal, and outputs the optical signal.

7. An optical communication system according to claim 5, wherein each signal relay apparatus further includes expansion and connection means for expanding and connecting the electronic apparatuses through the optical fiber cable.

8. An optical communication system according to claim 5, wherein the cable connector includes expansion and connection means for expanding and connecting the electronic apparatuses through the optical fiber cable.

9. An optical communication system according to claim 5,
wherein each signal relay apparatus includes:
a plurality of switch circuits for performing opening/closing operations to enable an electric signal from the adjacent photoelectric conversion means to be bypassed, the switch circuits being disposed in electric signal input/output terminals of the photoelectric conversion means;
current detecting means for supplying power from a power source to each electronic apparatus and detecting a value of a current flowing inside thereof to detect a connection status of the electronic apparatus, the current detecting means being disposed corresponding to the electronic apparatus; and
switch control means for controlling, when the connection status of the electronic apparatus is changed with respect to any of the photoelectric conversion means, opening/closing of each switch circuit to change a bypass status of the photoelectric conversion means corresponding to the electronic apparatus changed in connection status based on the connection status of each electronic apparatus, the status being detected by the current detecting means.

10. A signal relay apparatus in an optical communication system in which a plurality of electronic apparatuses are connected in a ring shape in a vehicle and an optical signal is relayed among the electronic apparatuses by use of an optical fiber cable, the signal relay apparatus comprising:
a plurality of photoelectric conversion means for converting an optical signal entered from the connected electronic apparatus into an electric signal to output the electric signal to other photoelectric conversion means and converting an electric signal entered from the other photoelectric conversion means into an optical signal to output the optical signal to the electronic apparatus, the photoelectric conversion means being disposed at least corresponding to the electronic apparatuses.

11. A signal relay apparatus according to claim 10, wherein the photoelectric conversion means amplifies the converted electric signal, converts the amplified electric signal into an optical signal, and outputs the optical signal.

12. A signal relay apparatus according to claim 10, wherein the photoelectric conversion means further includes expansion and connection means for expanding and connecting the electronic apparatuses through the optical fiber cable.

13. A signal relay apparatus according to claim 12, wherein the expansion and connection means includes:
a photoelectric conversion section for generating an electric signal of a level in accordance with a level of an entered optical signal; and
a signal monitoring section for monitoring the level of the electric signal generated by the photoelectric conversion section and determining whether the electronic apparatuses have been expanded and connected or not in accordance with the monitored level of the electric signal.

14. A signal relay apparatus according to claim 10, further comprising:
a plurality of switch circuits for performing opening/closing operations to enable an electric signal from the adjacent photoelectric conversion means to be bypassed, the switch circuits being disposed in electric signal input/output terminals of the photoelectric conversion means;
current detecting means for supplying power from a power source to each electronic apparatus and detecting a value of a current flowing inside thereof to detect a connection status of the electronic apparatus, the current detecting means being disposed corresponding to the electronic apparatus; and
switch control means for controlling, when the connection status of the electronic apparatus is changed with respect to any of the photoelectric conversion means, opening/closing of each switch circuit to change a bypass status of the photoelectric conversion means corresponding to the electronic apparatus changed in connection status based on the connection status of each electronic apparatus, the status being detected by the current detecting means.

15. An optical communication connector in an optical communication system in which a plurality of electronic apparatuses are connected in a ring shape in a vehicle and an optical signal is relayed among the electronic apparatuses by use of an optical fiber cable, the optical communication connector comprising:
first photoelectric conversion means for converting an optical signal transmitted from one optical fiber cable into an electric signal and converting an entered electric signal into an optical signal to send the optical signal; and
second photoelectric conversion means for converting an electric signal from the first photoelectric conversion means into an optical signal to send the optical signal to the other optical fiber cable and converting an entered optical signal into an electric signal to output the electric signal to the first photoelectric conversion means,
wherein any of the first photoelectric conversion means and the second photoelectric conversion means includes amplification means for amplifying any of the entered electric signal and the converted electric signal.

16. An optical communication connector according to claim 15, wherein any of the first photoelectric conversion means and the second photoelectric conversion means further includes expansion and connection means for expanding and connecting the electronic apparatuses through the optical fiber cable.

17. An optical communication connector according to claim 16,
wherein the expansion and connection means includes:
a photoelectric conversion section for generating an electric signal of a level in accordance with a level of an entered optical signal; and
a signal monitoring section for monitoring the level of the electric signal generated by the photoelectric conversion section and determining whether the electronic apparatuses have been expanded and connected or not in accordance with the monitored level of the electric signal.
